(19) United States
(12) Patent Application Publication
(10) Pub. No.: US 2021/0201605 A1
(43) Pub. Date: Jul. 1, 2021

(54) INFORMATION OUTPUT DEVICE, AND INFORMATION OUTPUT METHOD

(71) Applicant: ISUZU MOTORS LIMITED, Tokyo (JP)

(72) Inventors: Akihide OOGUSHI, Fujisawa-shi, Kanagawa (JP); Kazutaka OOISHI, Fujisawa-shi, Kanagawa (JP)

(21) Appl. No.: 17/272,184

(22) PCT Filed: Aug. 28, 2019
(86) PCT No.: PCT/JP2019/033627

§ 371 Date: Feb. 26, 2021

(30) Foreign Application Priority Data
Aug. 30, 2018 (JP) 2018-161730

(51) Int. Cl. G07C 5/08; B60Q 9/00

(52) U.S. Cl. CPC G07C 5/0816; G07C 5/085; B60Q 9/00

(57) ABSTRACT

This information output device is provided with: a detecting unit for detecting a rotational speed of an engine mounted in a vehicle; a storage unit for storing historical information indicating the history of a state in which the rotational speed was less than the rotational speed of the engine when idling; a storage control unit for causing the storage unit to store the historical information; and an output unit for outputting the historical information being stored by the storage unit.

### TECHNICAL FIELD

The present disclosure relates to an information output device and an information output method, and more particularly, to an information output device and an information output method for outputting historical information related to a vehicle.

### BACKGROUND ART

An exhaust pipe constituting an exhaust passage of an engine of a vehicle may be damaged (for example, Patent Literature 1). For example, in a state where a rotational speed of the engine is lower than a rotational speed of the engine at the time of idling (idling rotation speed), a vibration width of the exhaust pipe connected to the engine increases. When the exhaust pipe repeatedly receives such vibrations, the exhaust pipe may be damaged.

### CITATION LIST

### Patent Document

Patent Literature 1: JP-A-2017-31930

### SUMMARY OF THE INVENTION

### Technical Problem

Here, a frequency at which the rotational speed of the engine becomes lower than the idling rotational speed depends largely on an operation of a driver such as a shift operation, and there is a large individual difference. Accordingly, a risk of damage to the exhaust pipe differs for each vehicle.

Although it is conceivable to increase a thickness of the exhaust pipe in order to prevent the damage to the exhaust pipe, a weight of a vehicle body increases even for a vehicle having a small risk of damage to the exhaust pipe when the thickness of the exhaust pipe of the vehicle is uniformly increased. For this reason, a cost may be increased and fuel efficiency may be deteriorated. Therefore, it is required to predict the damage to the exhaust pipe caused by a vibration of the engine for each vehicle.

An object of the present disclosure is to provide an information output device or an information output method that can predict damage to an exhaust pipe caused by vibration of an engine.

### Solution to Problem

An information output device according to the present disclosure includes:

a detecting unit that detects a rotational speed of an engine mounted on a vehicle;

a storage unit that stores historical information indicating a history of a state where the rotational speed is lower than a rotational speed of the engine at a time of idling;

a storage control unit that causes the storage unit to store the historical information; and

an output unit that outputs the historical information stored in the storage unit.

The information output device may further include a reset unit that initializes, by an external input, the historical information stored in the storage unit. The information output device may further include a notifying unit that notifies that an exhaust pipe of the vehicle may be damaged, when the historical information satisfies a predetermined condition. The storage control unit may cause the storage unit to store, as the historical information, a cumulative value of time during which the rotational speed is lower than the rotational speed of the engine at the time of idling. The storage control unit may cause the storage unit to store, as the historical information, a cumulative value of a number of times for which the rotational speed is lower than the rotational speed of the engine at the time of idling.

An information output method of the present disclosure includes steps, executed by a computer, of:

detecting a rotational speed of an engine mounted on a vehicle;

causing a storage unit to store historical information indicating a history of a state where the rotational speed is lower than a rotational speed of the engine at a time of idling; and

outputting the historical information stored in the storage unit.

### Advantageous Effects of Invention

According to the information output device and the information output method of the present disclosure, it is possible to predict damage to an exhaust pipe due to vibration of an engine.

### BRIEF DESCRIPTION OF THE DRAWINGS

FIG. 1 is a diagram showing a configuration of a vehicle on which an information output device according to an embodiment is mounted.

FIG. 2 is a diagram showing a configuration of the information output device.

FIG. 3 is an S-N line diagram for showing a method for setting a reference value for determining whether the possibility of damage to the exhaust pipe of the vehicle has increased.

FIG. 4 is a flowchart for showing processing of determining the possibility of damage to the exhaust pipe by the information output device.

### DESCRIPTION OF EMBODIMENTS

[Overview of Information Output Device]

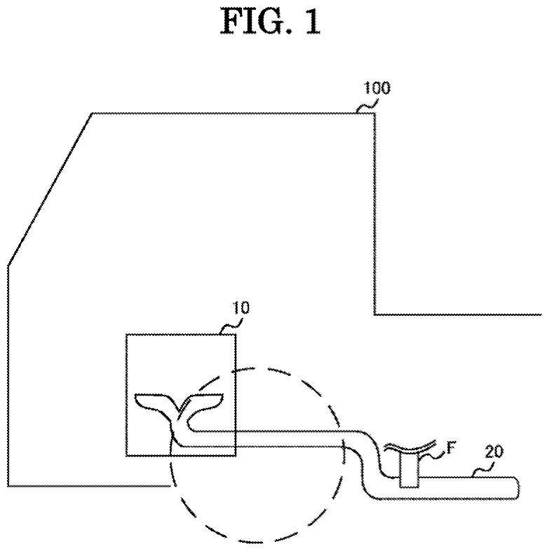

FIG. 1 is a diagram showing a configuration of a vehicle 100 on which an information output device according to an embodiment is mounted. An exhaust pipe 20 of the vehicle 100 is connected to the engine 10, and discharges exhaust gas of the engine 10 to an outside of the vehicle 100. The exhaust pipe 20 is suspended from a frame F of the vehicle body.

During rotation of the engine 10, vibration is transmitted to the exhaust pipe 20. Vibration energy E1 of the exhaust pipe 20 changes depending on a rotational speed of a crank of the engine 10 (hereinafter referred to as the engine rotational speed) and a vibration width of the exhaust pipe, and is expressed by the following equation (1).

E₁=α·f²·A² [Formula 1]

In the equation, α represents a coefficient, f represents an engine rotational speed, and A represents a vibration width. On the other hand, energy E2 at which the engine 10 vibrates the exhaust pipe 20 is expressed by the following equation (2).

E₂=β·f [Formula 2]

In the equation, β represents a coefficient. Here, since E1=E2, the vibration width A is expressed by the following equation (3).

$$\begin{matrix}[ Formula 3 ] & \\ A = \sqrt{\frac{β}{α \times f}} & ( 3 )\end{matrix}$$

As shown in the equation (3), the vibration width A increases as the engine rotational speed f decreases. The vehicle 100 employs a manual transmission method, and is automatically adjusted such that the engine rotational speed is not equal to or lower than the rotational speed of the engine 10 at the time of idling (hereinafter referred to as “idling rotational speed”) in a state where the clutch is not connected and in a neutral state. The idling rotational speed may be regarded as a lower limit value of the engine rotational speed in a state where the clutch of the vehicle is not connected.

On the other hand, in a state where a low speed gear such as a low gear or a second gear is connected in the engine 10, when the vehicle 100 travels at a low speed at the time of turning right or left at an intersection point or the like, the rotation of tires of the vehicle 100 is transmitted to the engine 10, and the engine 10 may rotate at a rotational speed lower than the idling rotation speed. When a state where the engine rotational speed is lower than the idling rotational speed is repeated, the exhaust pipe 20 may be fatigued and damaged by vibration with a large vibration width. For example, a part of the exhaust pipe 20 on which a urea water mixer (not shown) is disposed may be damaged. Therefore, the information output device of the present embodiment can predict the damage to the exhaust pipe 20 by outputting historical information indicating a history of a state where the engine rotational speed is lower than the idling rotational speed.

[Configuration of Information Output Device 200]

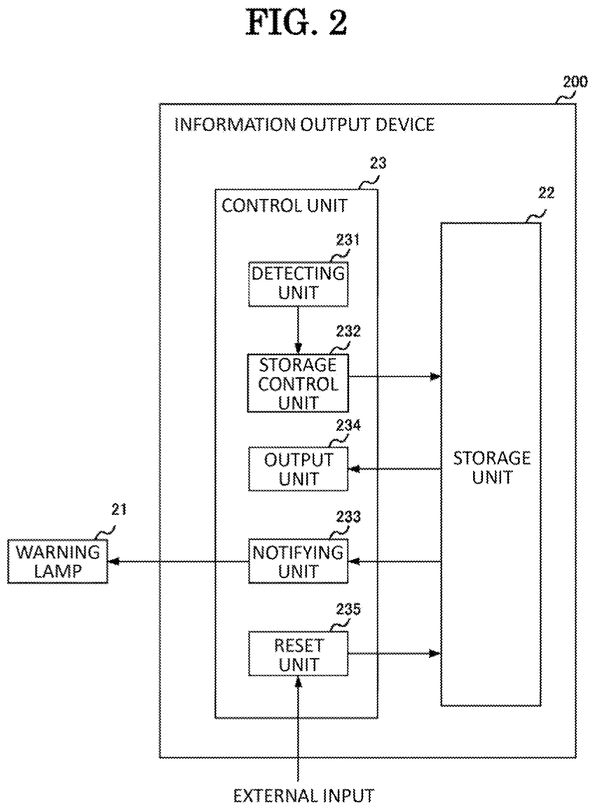

FIG. 2 is a diagram showing a configuration of the information output device 200. The information output device 200 is mounted on the vehicle 100. The information output device 200 is a computer that is connected to a warning lamp 21 and includes a storage unit 22 and a control unit 23. The warning lamp 21 is an indicator for notifying a user that the possibility of damage to the exhaust pipe 20 has increased. The warning lamp 21 is attached to, for example, an instrument panel. The storage unit 22 is a storage medium including a read only memory (ROM), a random access memory (RAM), and the like. The storage unit 22 stores a program executed by the control unit 23. The storage unit 22 is used as a work memory of the control unit 23.

The control unit 23 is, for example, a central processing unit (CPU). The control unit 23 functions as a detecting unit 231, a storage control unit 232, a notifying unit 233, an output unit 234, and a reset unit 235 by executing a program stored in the storage unit 22. The detecting unit 231 detects a rotational speed of the engine mounted on the vehicle 100. The reset unit 235 initializes the historical information, which is stored in the storage unit 22, depending on an external input.

The storage control unit 232 performs storage control of the storage unit 22. The storage control unit 232 determines whether the engine rotational speed detected by the detecting unit 231 is lower than the idling rotation speed of the vehicle. When the engine rotational speed detected by the detection unit 231 is lower than the idling rotational speed, the storage control unit 232 causes the storage unit 22 to store historical information indicating a history of a state where the engine rotational speed is lower than the idling rotational speed.

More specifically, the storage control unit 232 causes the storage unit 22 to store, as the historical information, a cumulative value of time during which the engine rotational speed is lower than the idling rotational speed starting from the time of delivery of the vehicle 100 or the time of previous replacement of the exhaust pipe 20. For example, the storage control unit 232 starts clocking when the engine rotational speed is lower than the idling rotational speed during traveling of the vehicle 100, and ends clocking when the engine rotational speed is equal to or higher than the idling rotational speed. The storage control unit 232 adds the measured time to the cumulative value of the time during which the engine rotational speed is lower than the idling rotational speed.

The notifying unit 233 notifies the user that the possibility of damage to the exhaust pipe 20 of the vehicle 100 has increased. The notifying unit 233 reads historical information, which is stored in the storage unit 22, at predetermined time intervals. When the read historical information satisfies a predetermined condition, the notifying unit 233 notifies that the possibility of damage to the exhaust pipe 20 of the vehicle 100 has increased. For example, when the cumulative value of the time during which the engine rotational speed is lower than the idling rotational speed in the read historical information exceeds a reference value, the notifying unit 233 notifies the user that the possibility of damage to the exhaust pipe 20 of the vehicle 100 has increased. As an example, the notifying unit 233 notifies that the possibility of damage to the exhaust pipe 20 of the vehicle 100 has increased by turning on the warning lamp 21. After the exhaust pipe 20 is repaired or replaced with a new one, the historical information stored in the storage unit 22 is initialized by the reset unit 235 that has received an external input signal. The external input signal is input by, for example, an operation of a button of an external device temporarily connected to the information output device 200.

With such a configuration, a driver can know in advance that the possibility of damage to the exhaust pipe of the vehicle 100 has increased. On the other hand, when the cumulative value of the time during which the engine rotational speed is lower than the idling rotational speed in the historical information is equal to or lower than the reference value, the notifying unit 233 does not notify that the possibility of damage to the exhaust pipe 20 of the vehicle 100 has increased.

The notifying unit 233 may output a signal to a communication device (not shown) provided in the vehicle 100 while turning on the warning lamp 21, and may transmit a signal, which indicates that the possibility of damage to the exhaust pipe 20 of the vehicle 100 has increased, to a management terminal device (not shown, for example, server terminals for dealers and service factories) provided at a position different from vehicle 100 via a network from the communication device. In this case, various kinds of pieces of information for specifying the vehicle 100 or the user may be transmitted together.

[S-N Line Diagram]

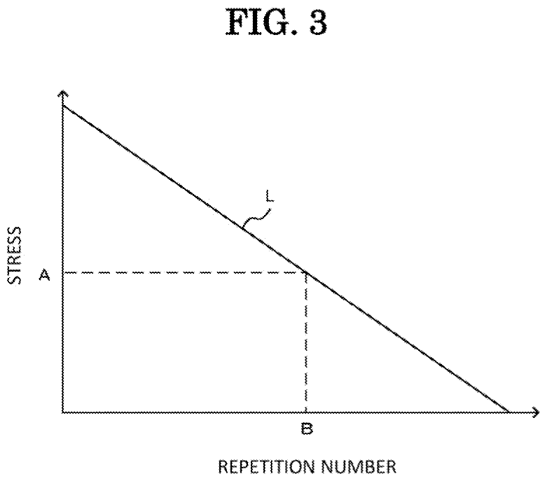

FIG. 3 is an S-N line diagram for showing a method for setting a reference value for determining whether the possibility of damage to the exhaust pipe 20 of the vehicle 100 has increased. The vertical axis of FIG. 3 indicates a magnitude of stress applied to the exhaust pipe 20, and the horizontal axis indicates the repetition number indicating how many times (Number) the stress is repeatedly applied to the exhaust pipe 20 to damage the exhaust pipe 20 in a manner of a logarithmic axis. A line L in FIG. 3 indicates a relation between the stress applied to the exhaust pipe 20 and the repetition number and is a substantially straight line. A manufacturer of the vehicle 100 measures stress applied to the exhaust pipe 20 for a plurality of times when the engine rotational speed is lower than the idling rotational speed, and determines an average value of the stress. When the determined average value of the stress is set to A, and the repetition number corresponding to A on the line L is B, and thus it can be understood that the exhaust pipe 20 is damaged when receiving stress at the Bth time.

The manufacturer converts the repetition number B into time and adds a margin in consideration of safety to the time, thereby determining a reference value at which the possibility of damage to the exhaust pipe 20 of the vehicle IM increases. When the cumulative value of the time during which the engine rotational speed in the historical information is lower than the idling rotational speed exceeds the reference value, the notifying unit 233 notifies the user that the exhaust pipe 20 of the vehicle 100 may be damaged.

Return to the description of FIG. 2. The output unit 234 outputs historical information stored in the storage unit 22. A serviceman at a dealer or a service factory instructs the output unit 234 to output the historical information stored in the storage unit 22 to an external device by using a dedicated tool at the time of vehicle inspection or the like of the vehicle 100. It is assumed that a serviceman at a dealer or a service factory has been notified in advance, by the manufacturer, of a reference value for determining whether the exhaust pipe 20 of the vehicle 100 may be damaged.

The serviceman browses the historical information output by the output unit 234 in the external device, and determines whether the cumulative value of the time during which the engine rotational speed is lower than the idling rotational speed in the historical information exceeds the reference value notified by the manufacturer. When the serviceman determines that the cumulative value of the time during which the engine rotational speed is lower than the idling rotational speed exceeds the reference value notified by the manufacturer, or when the serviceman determines that the cumulative value of the time exceeds the reference value before a next vehicle inspection, the serviceman guides the user to repair the exhaust pipe 20 of the vehicle 100 or replace the exhaust pipe 20 with a normal one (for example, a new one).

When the serviceman determines that the cumulative value of the time during which the engine rotational speed is lower than the idling rotational speed does not exceed the reference value before the next vehicle inspection, the serviceman does not guide the user to repair or replace the exhaust pipe 20 of the vehicle 100.

The output unit 234 may determine, with reference to the historical information stored in the storage unit 22, whether the cumulative value of the time during which the engine rotational speed is lower than the idling rotational speed exceeds the reference value, and may mark the determination result and output the historical information. For example, the output unit 234 may output historical information after attaching a mark * to a location where a reference value is exceeded in the historical information read from the storage unit 22. According to such a configuration, when the serviceman browses historical information, the output unit 234 can easily grasp whether the cumulative value of the time during which the engine rotational speed is lower than the idling rotational speed exceeds the reference value notified by the manufacturer.

[Processing of Determining Possibility of Damage to Exhaust Pipe 20]

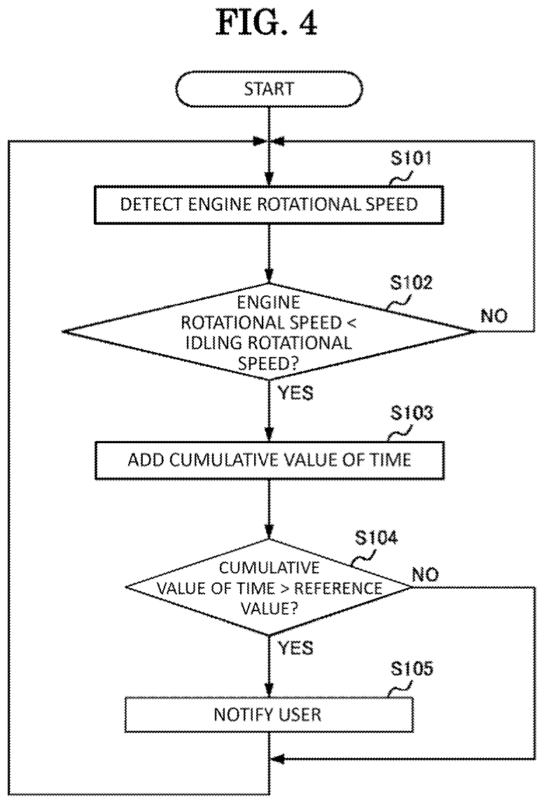

FIG. 4 is a flowchart for showing processing of determining the possibility of damage to the exhaust pipe 20 by the information output device 200. This processing procedure is started, for example, when a driver of the vehicle 100 starts the engine 10.

First, the detecting unit 231 detects a rotational speed of the engine mounted on the vehicle 100 (S101). Next, the storage control unit 232 determines whether the rotational speed detected by the detecting unit 231 is lower than the idling rotational speed (S102). When the rotational speed detected by the detecting unit 231 is lower than the idling rotational speed (YES in S102), the storage control unit 232 adds a cumulative value of time during which the rotational speed is lower than the idling rotational speed in the historical information stored in the storage unit 22 (S103).

The notifying unit 233 determines whether the cumulative value of the time during which the engine rotational speed is lower than the idling rotational speed in the historical information exceeds the reference value (S104). When the cumulative value of the time during which the engine rotational speed is lower than the idling rotational speed in the historical information exceeds the reference value (YES in S104), the notifying unit 233 notifies the user that the exhaust pipe 20 of the vehicle 100 may be damaged (S105), and returns to the processing of S101.

When the engine rotational speed detected by the detecting unit 231 is equal to or higher than the idling speed in the determination of S102 (NO in S102), the storage control unit 232 returns to the processing of S101. When the cumulative value of the time during which the engine rotational speed is lower than the idling rotational speed in the historical information is equal to or less than the reference value in the determination of S104 (NO in S104), the notifying unit 233 returns to the processing of S101.

According to the present embodiment, the storage control unit 232 causes the storage unit 22 to store historical information indicating a history of a state where the engine rotational speed is lower than the idling rotational speed, and the output unit 234 outputs the historical information stored in the storage unit 22. According to such a configuration, the replacement time of the exhaust pipe can be predicted by using the history of the state where the engine rotational speed is lower than the idling rotational speed.

The present embodiment has described an example in which the storage control unit 232 causes the storage unit 22 to store the cumulative value of the time during which the engine rotational speed is lower than the idling rotational speed as the historical information. However, the present disclosure is not limited to the example in which the cumulative value of time is stored, and the storage control unit 232 may cause the storage unit 22 to store the cumulative value of the number of times for which the engine rotational speed is lower than the idling rotational speed as historical information.

When the cumulative value of the number of times for which the engine rotational speed is lower than the idling rotational speed in the historical information read from the storage unit 22 exceeds a reference value, the notifying unit 233 notifies the user that the exhaust pipe 20 of the vehicle 100 may be damaged. On the other hand, when the cumulative value of the number of times for which the engine rotational speed is lower than the idling rotational speed in the historical information is equal to or less than the reference value, the notifying unit 233 does not notify the user that the exhaust pipe 20 of the vehicle 100 may be damaged. The reference value can be determined according to the S-N line diagram of FIG. 3, similarly to the reference value for the cumulative value of the time during which the engine rotational speed is lower than the idling rotational speed.

In a vehicle equipped with a manual transmission, driving may be performed in a state where the rotational speed of the engine is lower than the idling rotational speed. The frequency at which the rotational speed of the engine becomes lower than the idling rotational speed is large depending on the operation of the driver such as a shift operation, and there is a large individual difference. Accordingly, a risk of damage to the exhaust pipe differs for each vehicle.

Although it is conceivable to increase a thickness of the exhaust pipe in order to prevent the damage to the exhaust pipe, a weight of a vehicle body increases even for a vehicle of a driver, which has a small risk of damage to the exhaust pipe when the thickness of the exhaust pipe of the vehicle is uniformly increased. For this reason, a component cost may be increased and further, fuel efficiency may be deteriorated.

According to the present embodiment, the storage control unit 232 causes the storage unit 22 to store historical information indicating a history of a state where the engine rotational speed is lower than the rotational speed of the engine 10 at the time of idling, and the output unit 234 outputs the historical information stored in the storage unit 22. Accordingly, since it is possible to predict damage to the exhaust pipe caused by vibration of an engine according to a driving method of a part of drivers, an effect of suppressing an increase in the component cost due to an increase in the weight of the exhaust pipe and preventing deterioration of vehicle fuel efficiency is achieved, and an effect of on-road failure occurrence suppression due to prompting the driver to replace the components is achieved.

Although the present disclosure has been described above using the embodiment, the technical scope of the present disclosure is not limited to the scope described in the above embodiments, and various modifications and changes can be made within the scope of the gist of the present disclosure. For example, a specific embodiment of distributing and integrating devices is not limited to the embodiment described above, and all or a part of the devices may be configured to be functionally or physically distributed and integrated in any unit. Further, new embodiments generated by any combination of a plurality of embodiments are also contained in the embodiment of the present invention. Effects of the new embodiments generated by the combination include effects of the original embodiments.

The present application is based on Japanese Patent Application (Patent Application No. 2018-161730) filed on Aug. 30, 2018, and the contents thereof are incorporated herein by reference.

### INDUSTRIAL APPLICABILITY

The information output device and the information output method of the present disclosure are useful in predicting damage to an exhaust pipe caused by vibration of an engine.

### LIST OF REFERENCE NUMERALS

10 Engine
20 Exhaust pipe
21 Warning lamp
22 Storage unit
23 Control unit
100 Vehicle
200 Information output device
231 Detecting unit
232 Storage control unit
233 Notifying unit
234 Output unit
235 Reset unit

1. An information output device comprising:
a detecting unit that detects a rotational speed of an engine mounted on a vehicle;
a storage unit that stores historical information indicating a history of a state where the rotational speed is lower than a rotational speed of the engine at a time of idling;
a storage control unit that causes the storage unit to store the historical information; and
an output unit that outputs the historical information stored in the storage unit.

2. The information output device according to claim 1, further comprising:
a reset unit that initializes, by an external input, the historical information stored in the storage unit.

3. The information output device according to claim 1, further comprising:
a notifying unit that notifies that an exhaust pipe of the vehicle may be damaged, when the historical information satisfies a predetermined condition.

4. The information output device according to claim 1,
wherein the storage control unit causes the storage unit to store, as the historical information, a cumulative value of time during which the rotational speed is lower than the rotational speed of the engine at the time of idling.

5. The information output device according to claim 1,
wherein the storage control unit causes the storage unit to store, as the historical information, a cumulative value of a number of times for which the rotational speed is lower than the rotational speed of the engine at the time of idling.

6. An information output method comprising steps, executed by a computer, of:
detecting a rotational speed of an engine mounted on a vehicle;
causing a storage unit to store historical information indicating a history of a state where the rotational speed is lower than a rotational speed of the engine at a time of idling; and
outputting the historical information stored in the storage unit.
